(19) United States
(12) Patent Application Publication
(10) Pub. No.: US 2013/0011001 A1
(43) Pub. Date: Jan. 10, 2013

(54) SPEAKER SYSTEM AND MANUFACTURING METHOD THEREOF

(75) Inventors: Hiroki FUJIMORI, Nagano (JP); Masatoshi MIYASHITA, Nagano (JP)

(73) Assignee: MINEBEA CO., LTD., Kitasaku-Gun (JP)

(21) Appl. No.: 13/541,226

(22) Filed: Jul. 3, 2012

(30) Foreign Application Priority Data
Jul. 5, 2011 (JP) 2011-148961

(51) Int. Cl. H04R 1/00; H04R 31/00

(52) U.S. Cl. 381/413; 29/594

(57) ABSTRACT

A speaker system includes: a baffle board having a first attachment portion, a second attachment portion, and a third attachment portion; a diaphragm, which is exposed to a front face side of the baffle board; an edge, which is disposed on an outer circumference of the diaphragm and is fixed to the first attachment portion to support the diaphragm; a magnetic circuit holding member, which is configured to be fixed to the second attachment portion so that a magnetic circuit is holed at a rear face side of the diaphragm; and a damper, which is disposed at the rear face side of the diaphragm and is fixed to the third attachment portion to support the diaphragm.

### CROSS-REFERENCE TO RELATED APPLICATION

This application claims priority from Japanese Patent Application No. 2011-148961 filed on Jul. 5, 2011, the entire subject matter of which is incorporated herein by reference.

### TECHNICAL FIELD

This disclosure relates to a speaker system and a method of manufacturing the same, and more specifically, to a speaker system configured by incorporating components of a speaker unit into a baffle board, and a method of manufacturing the same.

### BACKGROUND

Speaker systems are widely used not only in various electronic devices for home audio equipment, such as a television receiver, a personal computer, or an audio system, but also in on-vehicle audio equipment. The speaker system in these electronic devices is required to be realized as a thin shape and be saved in space. For example, since the electronic devices have been reduced in size or thickness, some of the electronic devices secure an extremely narrow space for accommodating a speaker therein.

For example, in a box type speaker system of the related art, a speaker unit, which is separately assembled, fixed to a case forming a box shape. However, since the speaker unit has a frame to which a diaphragm or a magnetic circuit is attached, the structure of the speaker system is complicated. Further, there is a problem in that since the speaker unit has the frame, the speaker system has the thickness to some extent, so that it is difficult to reduce the thickness of the speaker system.

JP-A-H06-253381 discloses a box type speaker system including a diaphragm, which is directly fixed to a baffle board. In the box type speaker system, the frame of the speaker unit is provided with a portion for supporting a magnetic circuit and a portion to be bonded with a damper, and the magnetic circuit is supported by a rear face of the box.

JP-UM-A-S52-79922 discloses a speaker system including a frame of a speaker, and a cabinet, which is molded integrally with the frame by resin. In the speaker system, a portion of the cabinet serving as the frame portion is formed to be deeply narrowed towards the inside from a front face of the speaker, and various components of the speaker are attached to the narrowed portion.

However, the structure as disclosed in JP-A-H06-253381 necessarily includes the frame for fixing the magnetic circuit, and a voice coil is supported by the damper. Accordingly, there is a limit to decrease the thickness of the portion in which the baffle board is added to the speaker portion. Further, in the case of manufacturing the speaker system, after the box has been made in advance, it is necessary to attach the magnetic circuit or the like to the rear face side of the box and attach a diaphragm to the front face side of the box. Therefore, there is a problem in that a manufacturing process is complicated and the number of working steps is large, so that a manufacturing cost of the speaker system is increased.

Additionally, as disclosed in JP-UM-A-S52-79922, according to the structure in which the frame portion is formed to be deeply narrowed towards the inside from the front face of the speaker, it is difficult to reduce the thickness of the system and save the space.

Therefore, this disclosure provides at least a speaker system to be realized as a thin shape and to be easily manufactured and a method of manufacturing the same.

### SUMMARY

In view of the above, a speaker system comprises: a baffle board having a first attachment portion, a second attachment portion, and a third attachment portion; a diaphragm, which is exposed to a front face side of the baffle board; an edge, which is disposed on an outer circumference of the diaphragm and is fixed to the first attachment portion to support the diaphragm; a magnetic circuit holding member, which is configured to be fixed to the second attachment portion so that a magnetic circuit is holed at a rear face side of the diaphragm; and a damper, which is disposed at the rear face side of the diaphragm and is fixed to the third attachment portion to support the diaphragm.

In the above-described speaker system, the second attachment portion and the third attachment portion may be respectively positioned outer side than an edge roll portion of the edge.

In the above-described speaker system, the magnetic circuit holding member may have a cylindrical portion, in which the magnetic circuit is disposed, a plurality of engaging portions protruding laterally from the cylindrical portion, and the plurality of engaging portions may be fixed to the second attachment portion to be positioned at the second attachment portion.

In the above-described speaker system, a plurality of the dampers may be disposed at a substantially equal angle with respect to a center of a speaker attachment portion.

In the above-described speaker system, the damper may include: a fixing portion that is configured to be fixed to the third attachment portion; and a pair of movable portions that has a strip shape extending from the fixing portion to a center portion side of the diaphragm, and wherein the movable portions may be respectively attached to the center portion side of the diaphragm.

In the above-described speaker system, the pair of movable portions may be connected to each other at the center portion side of the diaphragm, and a portion connecting the pair of movable portions is fixed to the diaphragm.

In the above-described speaker system, the damper may be disposed on a straight line which passes through a center of the diaphragm and crosses at a right angle with the outer circumference of the diaphragm, and the pair of movable portions may be symmetrically disposed, with respect to the straight line, when seen from a direction substantially perpendicular to a vibration face of the diaphragm.

In the above-described speaker system, the first attachment portion may be formed at the front face side of the baffle board, and the edge may be attached to the first attachment portion from the front side of the baffle board.

In the above-described speaker system, the first attachment portion may be formed at a rear face side of the baffle board, and wherein the edge may be attached to the first attachment portion from the rear side of the baffle board.

In the above-described speaker system, the baffle board may have a fourth attachment portion at a rear face side thereof, and a terminal connected to a voice coil via a tinsel wire is fixed to the fourth attachment portion, and the fourth attachment portion may be positioned outer side than the edge roll portion of the edge.

In other aspect of this disclosure, a method of manufacturing a speaker system, in which a baffle board is attached with a diaphragm via an edge, a plurality of dampers supports the diaphragm, and a magnetic circuit holding member holds a magnetic circuit, and the dampers and the magnetic circuit holding member is attached to a rear face side of the baffle board, the method comprises: fixing the plurality of dampers to the baffle board attached with the diaphragm in a state in which the dampers are connected to each other via a bridge portion; and separating the plurality of dampers from each other by removing the bridge portion, after the fixing the plurality of dampers to the baffle board.

In the above-described method of manufacturing a speaker system, the method may comprises fixing the magnetic circuit holding member attached with the magnetic circuit to the baffle board so that the magnetic circuit is positioned at a center portion of the diaphragm, after separating the plurality of dampers from each other.

According to this disclosure, the baffle board is provided with the first attachment portion to which the edge is fixed, the second attachment portion to which the magnetic circuit holding member is fixed, and the third attachment portion to which the damper is fixed. Accordingly, the speaker system, which is to be realized as a thin shape and to be easily manufactured, and the method of manufacturing the same is achieved.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is an exploded perspective view illustrating a speaker system according to one embodiment of this disclosure;

FIG. 2 is a rear view illustrating a baffle board and a speaker section of the speaker system;

FIG. 3 is a cross-sectional view taken along the line A-A in FIG. 2;

FIG. 4 is a partially enlarged view of FIG. 3;

FIG. 5 is a flowchart illustrating a process of manufacturing the speaker system;

FIG. 6 is a first view illustrating the process of manufacturing the speaker system;

FIG. 7 is a second view illustrating the process of manufacturing the speaker system;

FIG. 8 is a third view illustrating the process of manufacturing the speaker system;

FIG. 9 is a fourth view illustrating the process of manufacturing the speaker system;

FIG. 10 is a fifth view illustrating the process of manufacturing the speaker system;

FIG. 11 is a sixth view illustrating the process of manufacturing the speaker system;

FIG. 12 is an exploded perspective view illustrating a speaker system according to one modification of this disclosure;

FIG. 13 is a cross-sectional view illustrating a speaker section of the speaker system; and

FIG. 14 is a view illustrating a speaker system according to another modification of this disclosure.

### SUMMARY

Next, a speaker system according to one embodiment of this disclosure will now be described.

### Illustrative Embodiment

In this embodiment, a speaker system 1 is a box type speaker. The speaker system 1 includes a plurality of dampers for supporting a diaphragm and a magnetic circuit holding member for holding a magnetic circuit, at a rear face side of a baffle board to which the diaphragm is attached via an edge. In the speaker system 1, all components of a speaker unit are attached to the baffle board.

### Description of Structure of Speaker System 1

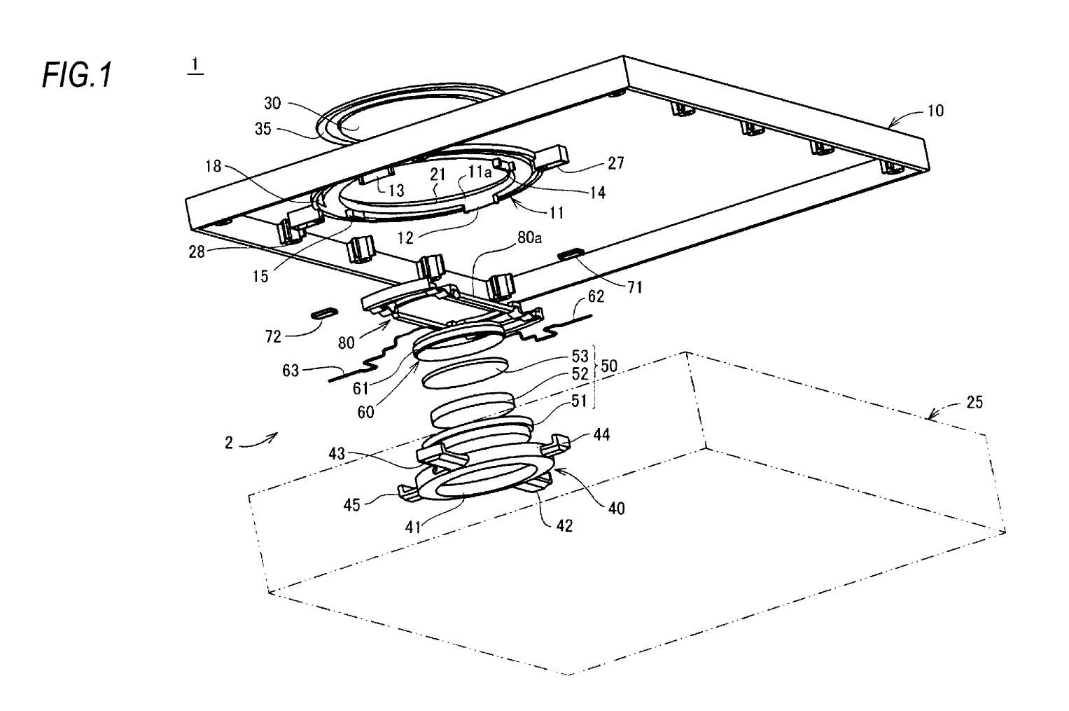

FIG. 1 is an exploded perspective view illustrating the speaker system 1 according to one embodiment of this disclosure.

As illustrated in FIG. 1, the speaker system 1 includes a thin speaker section 2, a baffle board 10 with the speaker section 2 attached to its front face (a left and upward face in FIG. 1), and a rear housing 25 (indicated by a chain double-dashed line in FIG. 1) covering a rear side of the baffle board 10. The speaker system 1 is a box type, in which the speaker section 2 is attached to an enclosure configured by the baffle board 10 and the rear housing 25.

The baffle board 10 is formed in the shape of flat plate, for example, and is disposed at a front side of the speaker system 1. The baffle board 10 is provided with a speaker attachment portion 11 to which the speaker section 2 is attached. The speaker attachment portion 11 has an opening portion 11a formed at a center portion thereof, and a diaphragm 30 of the speaker section 2 is disposed in the opening portion 11a. Around the opening portion 11a, the baffle board 10 is provided with four protrusions (one example of a second attachment portion) 12, 13, 14 and 15, a damper attachment portion (one example of a third attachment portion) 18, an edge attachment portion (one example of a first attachment portion) 21, and two terminal attachment portions (one example of a fourth attachment portion) 27 and 28. The protrusions 12 to 15, the damper attachment portion 18, and the terminal attachment portions 27 and 28 are formed on the rear face side (inner face side of the enclosure of the speaker system 1). Meanwhile, the edge attachment portion 21 is formed on the front side (front side of the speaker system 1) of the baffle board 10.

The baffle board 10 is formed, for example, as an integral part configured by resin. That is, all portion of the baffle board 10 is integrally formed by resin molding.

The speaker section 2 includes the diaphragm 30, an edge 35, a magnetic circuit holding member (hereinafter, referred to simply as a holding member as appropriate) 40, a magnetic circuit 50, a voice coil bobbin 60, terminals 71 and 72, and a damper 80. The speaker section 2 is configured to attach to the baffle board 10 by fixing the edge 35, the holding member 40, the terminals 71 and 72, and the damper 80 to the baffle board 10 respectively. The speaker section 2 is entirely formed in a thin shape. The speaker section 2 is incorporated into the baffle board 10, with the diaphragm 30 and the edge 35 being attached to the speaker attachment portion 11 from the front side of the baffle board 10, and another member being attached to the speaker attachment portion 11 from the rear side of the baffle board 10. That is, the speaker system 1 includes a configuration different from one, in which a speaker unit assembled in advance to perform by itself is attached to a baffle board.

In FIG. 1, the damper 80 is illustrated as a pre-assembled state of the speaker system 1. However, the damper 80 may have a different shape in the speaker system which is assembled and used in practice. That is, the damper 80 illustrated in FIG. 1 is in a manufacturing process and has a bridge portion 80a, which is to be finally removed. The final shape or configuration of the damper or the detailed manufacturing process will be described later.

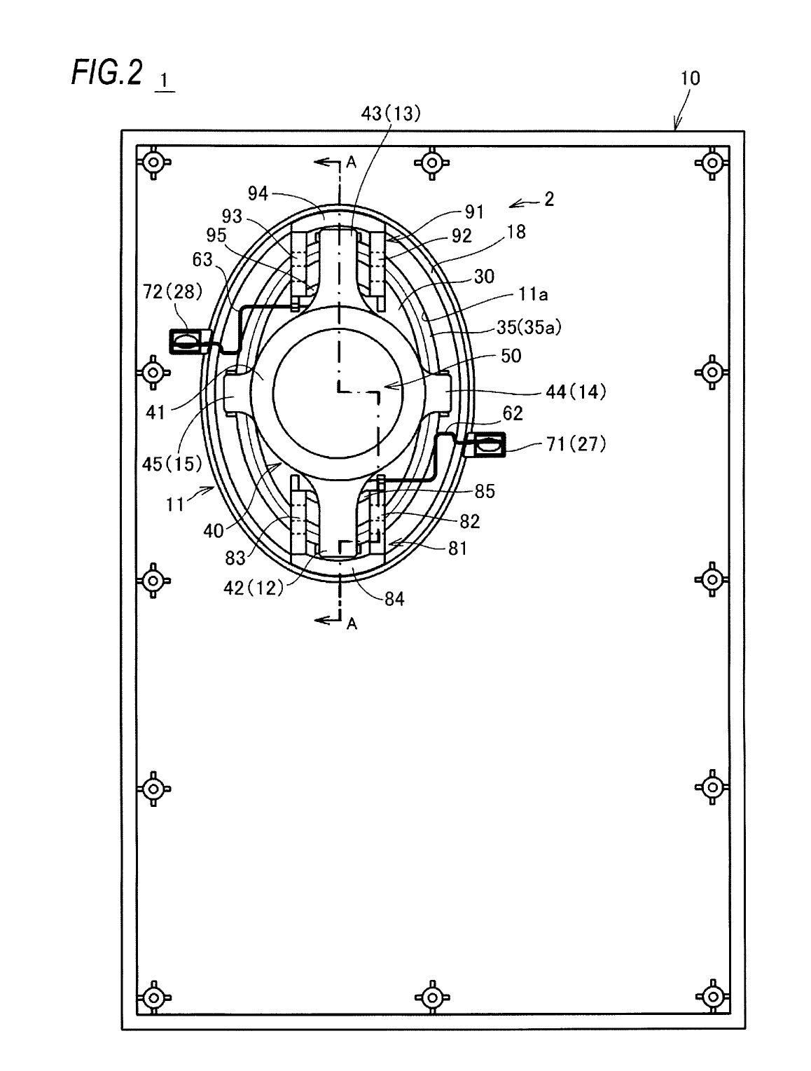

FIG. 2 is a rear view illustrating the baffle board 10 and the speaker section 2 of the speaker system 1.

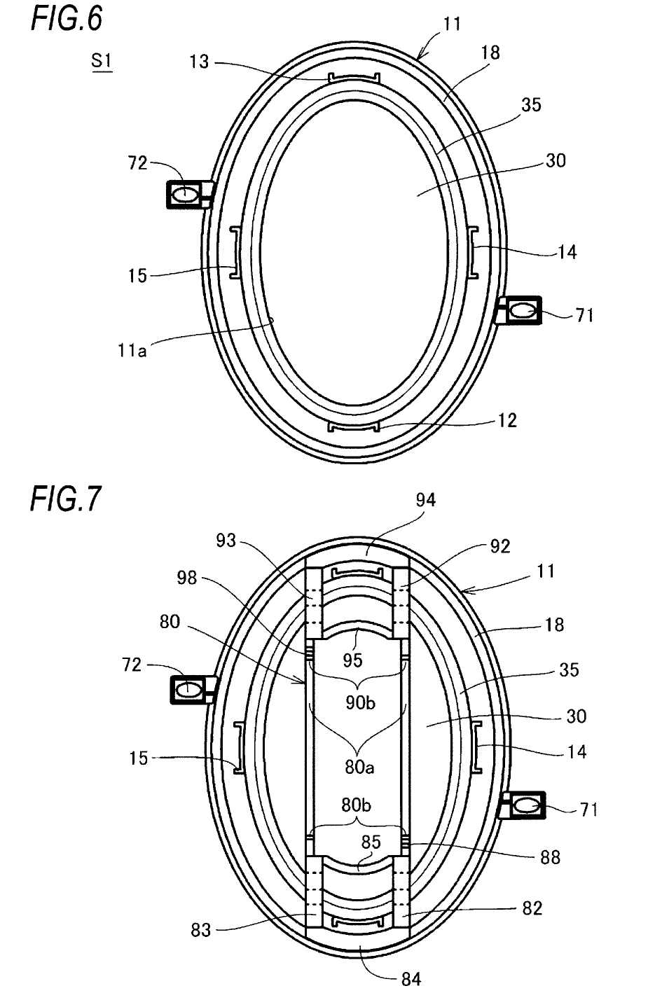

As illustrated in FIG. 2, the diaphragm 30 is formed in the shape of an oval plate. Also, the edge 35 is disposed on an outer circumference of the diaphragm 30 and forms an annual shape. The diaphragm 30 is disposed so that a long axis direction of the diaphragm 30 is corresponding to an up-and-down direction (up-and-down direction in FIG. 2). Meanwhile, the whole shape of the diaphragm 30 and the edge 35 when seen from the rear face is illustrated in FIG. 6, which will be described later. The diaphragm 30 may be formed in the shape of elliptical track (oval) configured by two half arcs and two straight lines.

The diaphragm 30 is attached to the baffle board 10 in the state in which the edge 35 is supported, with the edge 35 being fixed to the baffle board 10. In this embodiment, the edge 35 is attached to the edge attachment portion 21 from the front side of the baffle board 10. The diaphragm 30 is exposed from the front side of the baffle board 10. An edge roll portion 35a is formed between the portion of the edge 35 which is bonded to the diaphragm 30, and the portion of the baffle board 10 which is fixed to the edge attachment portion 21. The edge roll portion 35a has, for example, a wavy bent shape when seen from a cross-section perpendicular to the outer circumference of the diaphragm 30. Since the edge roll portion 35a is provided, the diaphragm 30 can be displaced in a forward-and-rearward direction (direction perpendicular to the paper of FIG. 2) of the speaker system 1.

In the baffle board 10, the opening portion 11a has a shape similarly to that of the diaphragm 30. The opening portion 11a is formed to have a size slightly smaller than that of an outer shape of the edge 35 by a margin when the edge is attached to the edge attachment portion 21. The protrusions 12 to 15 are respectively formed on lower, upper, right (right in FIG. 2) and left (left in FIG. 2) portions of the speaker attachment portion 11. The protrusions 12 to 15 are respectively disposed adjacent to an end edge portion of the opening portion 11a. The damper attachment portion 18 is a recessed portion having a predetermined width, which is formed along an oval substantially similar to the end edge portion of the opening portion 11a. The terminal attachment portion 27 is provided at the right lower side of the speaker attachment portion 11 and adjacent to the protrusion 14. Further, the terminal attachment portion 28 is provided at a left upper side of the speaker attachment portion 11 and adjacent to the protrusion 15.

As illustrated in FIG. 1, the holding member 40 has a cylindrical portion 41 formed on its center portion, and four engaging bosses (one example of an engaging portion) 42, 43, 44 and 45 protruding from the cylindrical portion 41 towards a side direction of the cylindrical portion 41. The magnetic circuit 50 is fixedly inserted into the cylindrical portion 41 from the front side of the holding member 40. In this embodiment, the magnetic circuit 50 is an internal magnet type. The magnetic circuit 50 has a pot yoke 51, a magnet 52, and a pole piece 53. The pot yoke 51 is formed in a cup shape when seen from the front. The magnet 52 is formed in a disc shape, and is disposed in the pot yoke 51. The pole piece 53 is formed in a disc shape and is disposed at the front of the magnet 52. A circular magnetic gap is formed between the pole piece 53 and a front-end portion of the pot yoke 51 when seen from the front. The magnetic circuit 50 is fixed to the holding member 40, with the pot yoke 51 being fitted into the cylindrical portion 41.

The holding member 40 is positioned by the protrusions 12 to 15, with the engaging bosses 42 to 45 being respectively bonded to the protrusions 12 to 15 of the baffle board 10. As illustrated in FIG. 2, the engaging bosses 42 and 43 are disposed so that the engaging bosses are divided into upper and lower sides of the diaphragm 30 in the long axis direction thereof with respect to the cylindrical portion 41. Also, the engaging bosses 44 and 45 are disposed so that the engaging bosses are divided into right and left sides of the diaphragm 30 in a short axis direction thereof on the basis of the cylindrical portion 41. That is, the holding member 40 has the engaging bosses 42 to 45, which protrude upward, downward, left and right in a cross shape with respect to the cylindrical portion 41 when seen from its bottom face. The engaging bosses 44 and 45 corresponding to the short axis direction of the diaphragm 30 are formed to have a distance shorter than that of the engaging bosses 42 and 43 corresponding to the long axis direction of the diaphragm 30.

The protrusions 12 to 15 are formed to have a U-shaped cross-section which is parallel to a bottom face of the opening portion 11a, so that the protrusions protrude rearward from the proximity of the end edge portion of the opening portion 11a, as illustrated in the drawings. The engaging bosses 42 to 45 of the holding member 40 have a claw-shaped portion, respectively, of which its leading end portion is bent toward the front side. The claw-shaped portion of the respective engaging bosses 42 to 45 is contacted and fixed to the respective protrusions 12 to 15. In this way, the holding member 40 is precisely positioned. That is, the magnetic circuit 50 is held by the holding member 40 in the state in which the magnetic circuit is precisely positioned on the speaker attachment portion 11.

The voice coil bobbin 60 is formed in a thin (short in height) cylindrical shape. The voice coil bobbin 60 is attached to a rear face of the diaphragm 30. The voice coil bobbin 60 has a voice coil 61, which is disposed in the magnetic gap of the magnetic circuit 50 (for example, see FIG. 4). The voice coil 61 is connected to two tinsel wires 62 and 63. The tinsel wires 62 and 63 are respectively connected to the terminals 71 and 72.

The terminals 71 and 72 are fixed to the terminal attachment portions 27 and 28 of the baffle board 10. The terminals 71 and 72 are attached to the baffle board 10 so that the terminals are exposed to the rear side thereof.

As illustrated in FIG. 1, the damper 80 is configured in one piece at the assembling step of the speaker system 1. As illustrated in FIG. 2, two dampers 81 and 91 are disposed in the speaker section 2 in the state in which the speaker system 1 is assembled. That is, as described later, the damper 80 of one piece is separated into two pieces at the time of assembling the speaker system 1. The damper 91 has the same shape as that of the damper 81, but is not limited thereto.

The dampers 81 and 91 are separated into two upper and lower pieces, which are respectively disposed at a peripheral portion of the speaker section 2. The dampers 81 and 91 are disposed so that its center portion is positioned on the long axis of the diaphragm 30. That is, the dampers 81 and 91 are disposed on a straight line, which passes through the center of the diaphragm 30 and crosses at a right angle with the outer circumference of the diaphragm 30. The two dampers 81 and 91 are disposed at a substantially equal angle with respect to the center of the speaker attachment portion 11. The two dampers 81 and 91 are point-symmetrically disposed at an interval of 180 degrees in a rotational direction around the center portion of the diaphragm 30.

The damper 81 has a pair of movable portions 82 and 83, a fixing portion 84, and a connection portion 85. Similarly, the damper 91 has a pair of movable portions 92 and 93, a fixing portion 94, and a connection portion 95.

The dampers 81 and 91 are respectively fixed to the damper attachment portion 18 at the fixing portions 84 and 94. The movable portions 82, 83, 92 and 93 have a strip shape extending to the center portion of the diaphragm 30 from the fixing portions 84 and 94. The movable portions 82, 83, 92 and 93 have flexibility in a forward-and-rearward direction, that is, a direction perpendicular to the diaphragm 30. The movable portions 82, 83, 92 and 93 are formed in a straight shape when seen from the rear face (when seen from a direction substantially perpendicular to a vibration face of the diaphragm 30) so that its longitudinal direction is parallel with the long axis of the diaphragm 30. The movable portion 82 and the movable portion 83 are formed substantially symmetrical to each other with respect to the long axis of the diaphragm 30. Similarly, the movable portion 92 and the movable portion 93 are formed substantially symmetrical to each other with respect to the long axis of the diaphragm 30.

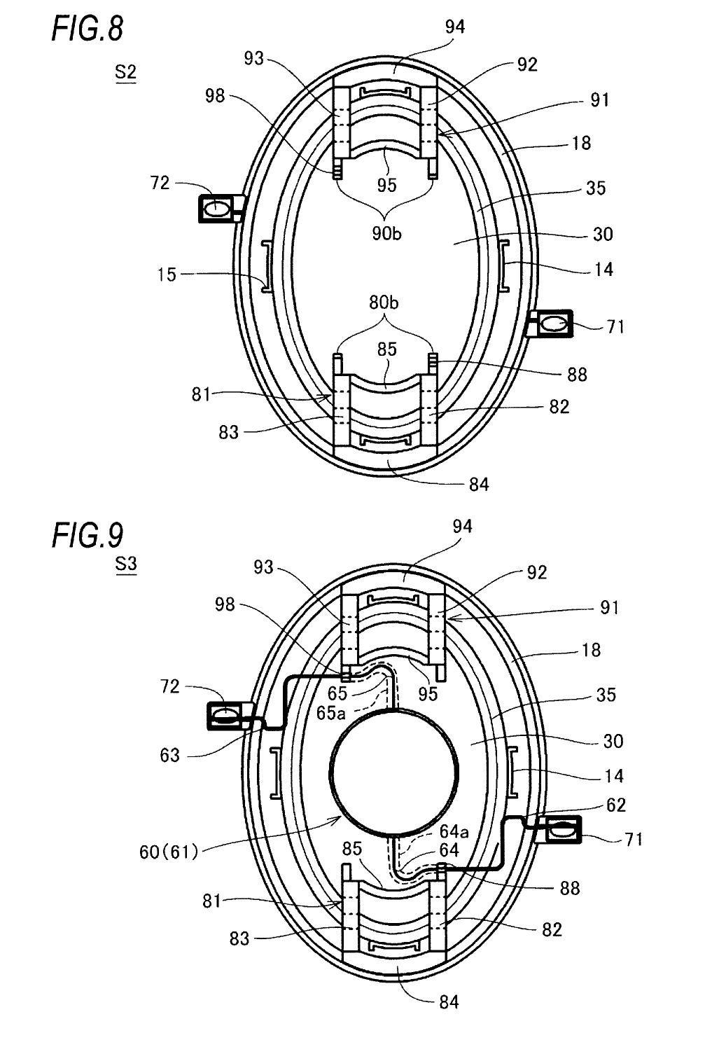

The connection portion 85 is connected to each upper end portions of the movable portions 82 and 83, that is, the portion at the center portion side of the diaphragm 30. The connection portion 85 connects both movable portions 82 and 83 at their upper end portions. Similarly, the connection portion 95 is connected to each upper end portions of the movable portions 92 and 93, that is, the portion at the center portion side of the diaphragm 30. The connection portion 95 connects both movable portions 92 and 93 at their upper end portions. The connection portions 85 and 95 are formed in a curved shape, that is, an arch shape when seen from the rear face, so that its center portion has a shape similarly to the outer circumference of the diaphragm 30 (for example, it is illustrated in FIG. 8 which will be described later).

The damper 81 is attached to the rear face of the diaphragm 30 at leading end portions of the movable portions 82 and 83 including the connection portion 85. Similarly, the damper 91 is attached to the rear face of the diaphragm 30 at leading end portions of the movable portions 92 and 93 including the connection portion 95. The dampers 81 and 91 support the diaphragm 30 and the voice coil bobbin 60 connected to the diaphragm 30. Since the movable portions 82, 83, 92 and 93 have the flexibility in the forward-and-rearward direction, the diaphragm 30 can be displaced in the forward-and-rearward direction with deforming the movable portions 82, 83, 92 and 93 and the edge 35.

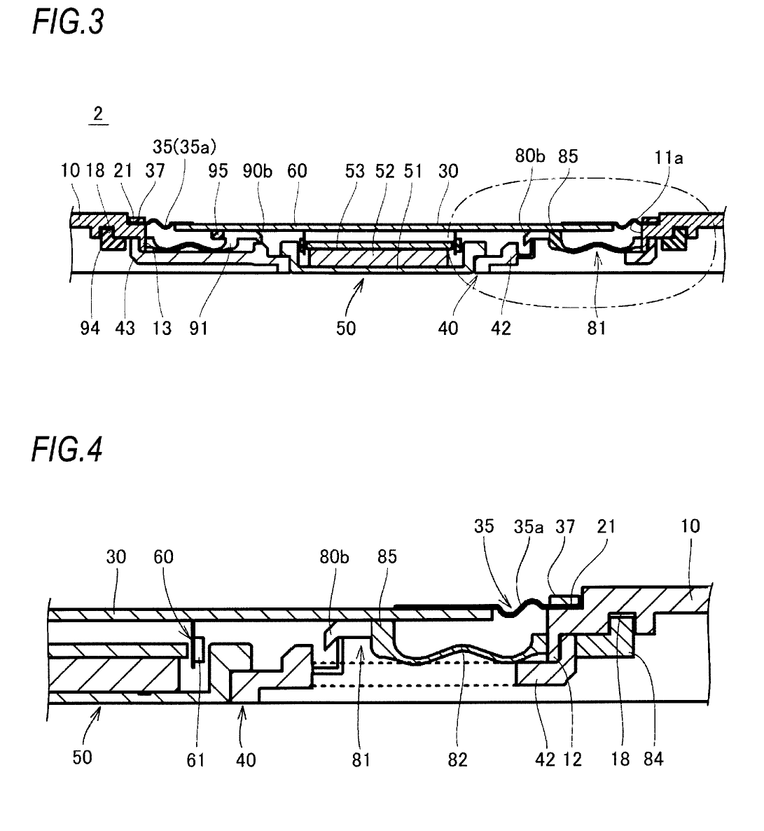

FIG. 3 is a cross-sectional view taken along the line A-A in FIG. 2. FIG. 4 is a partially enlarged view of FIG. 3.

FIG. 4 is the enlarged view of the portion circled by a dashed line in FIG. 3.

As illustrated in FIG. 3, the edge attachment portion 21 has a cross-section of a stepped shape, which is depressed in one step towards the rear side (downward in FIG. 3) from the front side (upward in FIG. 3) of the baffle board 10. The edge attachment portion 21 is formed in an annular shape around the opening portion 11a when seen from the front.

As illustrated in FIG. 4, the edge 35 has a wavy cross-section. The edge 35 has an edge end portion 37 formed to surround the outer circumference of the edge roll portion 35a. The edge end portion 37 is formed to have a thickness thicker than that of the edge roll portion 35a. Since the edge end portion 37 is provided, the shape of the edge 35 is generally maintained in the state, in which the edge 35 is attached to the edge attachment portion 21. The edge 35 is attached to the diaphragm 30 at an inner peripheral side of the edge roll portion 35a. The edge 35 and the diaphragm 30 are attached to the baffle board 10 by attaching the edge end portion 37 to the edge attachment portion 21.

As illustrated in FIG. 4, the fixing portion 84 of the damper 81 has an L-shaped cross-section, of which a lower end portion (right end in FIG. 4) protrudes upward. The protruding portion of the fixing portion 84 is formed to be fitted into the damper attachment portion 18 of a recess shape. The damper 81 is positioned with respect to the baffle board 10, since the fixing portion 84 is fitted into the damper attachment portion 18. The fixing portion 84 is attached and fixed to the damper attachment portion 18.

The movable portion 82 of the damper 81 extends from the fixing portion 84 to the center portion of the diaphragm 30 substantially parallel with the diaphragm 30. The movable portion 82 is formed in the strip shape having a wavy thin cross-section (cross-section illustrated in FIG. 4) in its longitudinal direction. Since the movable portion 82 is formed of the wave shape, the damper 81 can be easily bent in any of the forward-and-rearward direction (up-and-down direction in FIG. 4), so that the diaphragm 30 is smoothly vibrated. The leading end portion of the movable portion 82 toward the center portion side of the diaphragm 30 is bent in the front side to come in contact with the rear face of the diaphragm 30. The movable portion 83 also has the same cross-section as that of the movable portion 82. In the damper 81, the leading end portions of the movable portions 82 and 83 and the front side of the connection portion 85 formed between the movable portions are formed to follow the rear face of the diaphragm 30.

As illustrated in FIG. 3, the damper 91 also has the same configuration as that of the damper 81. The leading end portions of the movable portions 82 and 83 of the damper 81 at the center portion side of the diaphragm 30 are provided with a protrusion 80b. The leading end portions of the movable portions 92 and 93 of the damper 91 toward the center portion side of the diaphragm 30 are provided with a protrusion 90b. The protrusions 80b and 90b are formed to follow the diaphragm 30. The dampers 81 and 91 are attached to the diaphragm 30 at the protrusions 80b and 90b.

The speaker system 1 employs a signal cable or the like which is connected to the terminals 71 and 72 from the rear side of the speaker section 2. If a signal is applied to the terminals 71 and 72, the voice coil 61 is driven, and thus the voice coil bobbin 60 and the diaphragm 30 are displaced with respect to the magnetic circuit 50. That is, the speaker section 2 is operated by a voltage applied to the terminals 71 and 72 via the signal cable.

### Description of Process for Manufacturing Speaker System 1

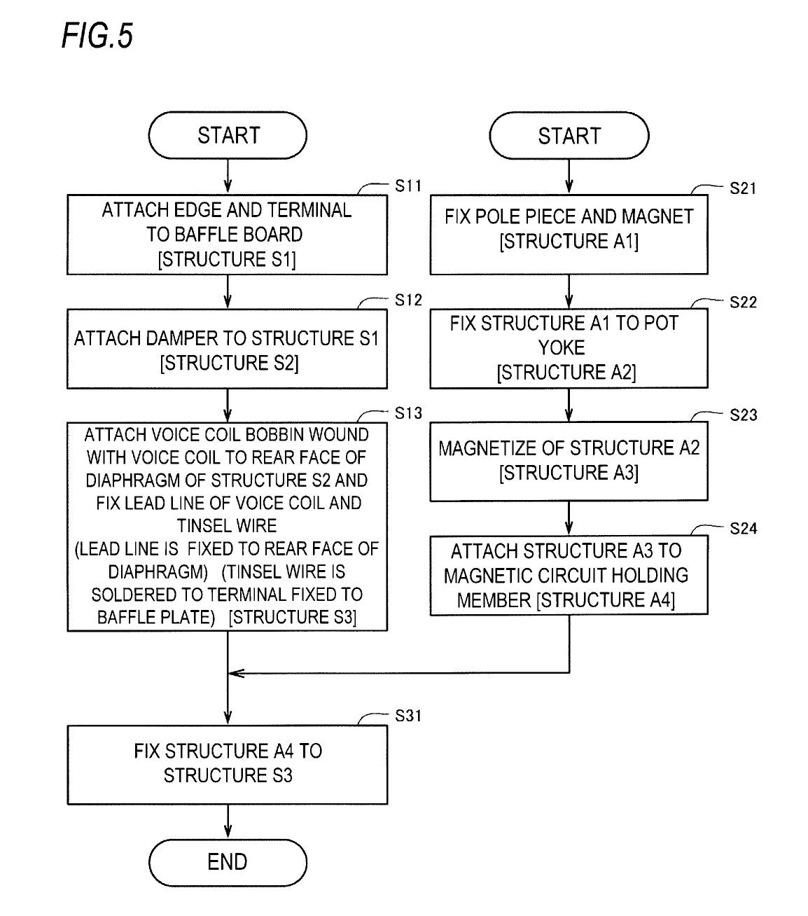

FIG. 5 is a flowchart illustrating the process of manufacturing the speaker system 1.

As illustrated in FIG. 5, the speaker system 1 is generally manufactured by a process (S11 to S13) of attaching each component to the baffle board 10, except for the magnetic circuit 50 and the holding member 40, a process (S21 to S24) of assembling the magnetic circuit 50 and the holding member 40, and a process (S31) of assembling the structures made via the two processes.

That is, at step S11, the edge 35 attached with the diaphragm 30 is attached to the edge attachment portion 21 of the baffle board 10. Further, the terminals 71 and 72 are attached to the terminal attachment portions 27 and 28. In this way, a structure 51 is obtained.

FIG. 6 is a first view illustrating a process of manufacturing the speaker system 1.

As illustrated in FIG. 6, in the structure 51, the opening portion 11a is covered by the edge 35 and the diaphragm 30. The edge 35 is attached to the baffle board 10 together with the diaphragm 30, in the state in which the edge 35 is bonded to the diaphragm 30 in advance. The diaphragm 30 is disposed from the front side of the baffle board 10, and is exposed to the front side of the baffle board 10. The rear face of the diaphragm 30 is exposed to the rear side of the baffle board 10 through the opening portion 11a.

As illustrated in FIG. 5, the structure 51, that is, the dampers 81 and 91 are attached to the baffle board 10 attached with the diaphragm 30 at step S12. In this way, a structure S2 is obtained.

In this embodiment, the dampers 81 and 91 are attached to the baffle board 10 as follows. That is, like the damper 80 illustrated in FIG. 1, the dampers 81 and 91 are first fixed to the baffle board 10 in the state in which the dampers are connected to each other via the bridge portion 80a. After that, by removing the bridge portion 80a, the two dampers 81 and 91 are separated from each other in the state while the dampers are attached to the baffle board 10.

FIG. 7 is a second view illustrating a process of manufacturing the speaker system 1.

As illustrated in FIG. 7, the dampers 81 and 91 are connected to each other via the bridge portion 80a (that is, the damper 80) before the dampers are attached to the baffle board 10. The damper 80 is configured so that, via the bridge portion 80a, the movable portion 82 and the movable portion 92 are connected to each other, and the movable portion 83 and the movable portion 93 are connected to each other.

The two bridge portions 80a having a straight shape are disposed in the up-and-down direction in FIG. 7. One bridge portion 80a is connected in the up-and-down direction between the protrusion 80b of the movable portion 82 and the protrusion portion 90b of the movable portion 92. Similarly, the other bridge portion 80a is formed between the protrusion 80b of the movable portion 83 and the protrusion portion 90b of the movable portion 93. The bridge portions 80a are formed to have the width narrower than that of the movable portion 82 or the movable portion 92. Each portion of the bridge portions 80a, which are connected to the protrusions 80b and 90b, is configured so that a cross-section perpendicular to its longitudinal direction has a small area. Accordingly, the portion can be easily cut.

The damper 80 is attached to the structure 51 from the rear side of the baffle board 10. The damper 80 is disposed in the speaker attachment portion 11 so that the fixing portion 84 forming the damper 81 and the fixing portion 94 forming the damper 91 are fitted into the damper attachment portion 18. The fixing portions 84 and 94 are attached and fixed to the damper attachment portion 18. In this way, the damper 80 is fixed to the speaker attachment portion 11. Also, each leading end portion of the movable portions 82, 83, 92 and 93, the protrusions 80b and 90b, and the connection portions 85 and 95 are attached and fixed to the rear face of the diaphragm 30.

FIG. 8 is a third view illustrating a process of manufacturing the speaker system 1.

As illustrated in FIG. 8, after the damper 80 is attached to the baffle board, the two bridge portions 80a of the damper 80 are removed from the damper 80 by cutting the bridge portions from the connection portions between the protrusions 80b and 90b. As the bridge portions 80a are removed, as illustrated in FIG. 8, the damper 81 and 91 are separated from each other. The respective dampers 81 and 91 is fixed to the baffle board 10 and the diaphragm 30 in the state in which the dampers are positioned. In this way, the structure S2 is obtained.

As illustrated in FIG. 5, at step S13, the voice coil bobbin 60 having the voice coil 61 wound around it in advance is attached to the structure S2. Also, the tinsel wires 62 and 63 are attached to the voice coil 61. In this way, a structure S3 is obtained.

FIG. 9 is a fourth view illustrating a process of manufacturing the speaker system 1.

As illustrated in FIG. 9, the voice coil bobbin 60 is positioned on the center portion of the rear face of the diaphragm 30. The voice coil bobbin 60 is attached and fixed to the diaphragm 30. The voice coil 61 is respectively connected to the tinsel wire 62 via a lead line 64, and the tinsel wire 63 via a lead line 65. The lead lines 64 and 65 are end portions of a winding line as the voice coil 61. The lead lines 64 and 65 are respectively connected to the tinsel wires 62 and 63 by soldering or the like. After the voice coil bobbin 60 is attached to the diaphragm 30, the lead lines 64 and 65 are respectively fixed to the rear face of the diaphragm 30 by adhesives 64a and 65a or the like.

The connection portions between the lead lines 64 and 65 and the tinsel wires 62 and 63 are fitted into relay portions 88 and 98, which are formed on the dampers 81 and 91, and then are attached and fixed thereto. The relay portion 88 is formed on the protrusion 80b of the movable portion 82, which is positioned at the side close to the terminal 71. Also, the relay portion 98 is formed on the protrusion 90b of the movable portion 93 which is positioned at the side close to the terminal 72. The relay portions 88 and 98 have, for example, a clip shape (half ring shape) of a U-shaped cross-section which can position the connection portions between the lead lines 64 and 65 and the tinsel wires 62 and 63 therein.

The tinsel wires 62 and 63 are respectively disposed from the portions, which are fixed to the relay portions 88 and 98, to the respective terminals 71 and 72 so as not to interrupt movement of the diaphragm 30. The tinsel wires 62 and 63 are connected to the terminals 71 and 72 by soldering or the like. Accordingly, an electric current is to flow in the voice coil 61 via the terminals 71 and 72.

In this way, the components are attached to the baffle board 10 to configure the structure S3, and the magnetic circuit 50 and the holding member 40 are assembled.

That is, as illustrated in FIG. 5, the pole piece 53 is fixedly attached to the magnet 52 at step S21. In this way, a structure A1 is obtained.

At step S22, the structure A1 is attached and fixed to the pot yoke 51. In this way, a structure A2 is obtained.

At step S23, the structure A2 is subjected to magnetization. In this way, a structure A3 is obtained. The structure A3 is the magnetic circuit 50.

At step S24, the structure A3 is attached to the holding member 40. In this way, a structure A4, that is, the holding member 40 with the magnetic circuit 50 being held therein is obtained. Meanwhile, the magnetization of the magnetic circuit 50 may be performed in the state in which the magnetic circuit 50 is held by the holding member 40.

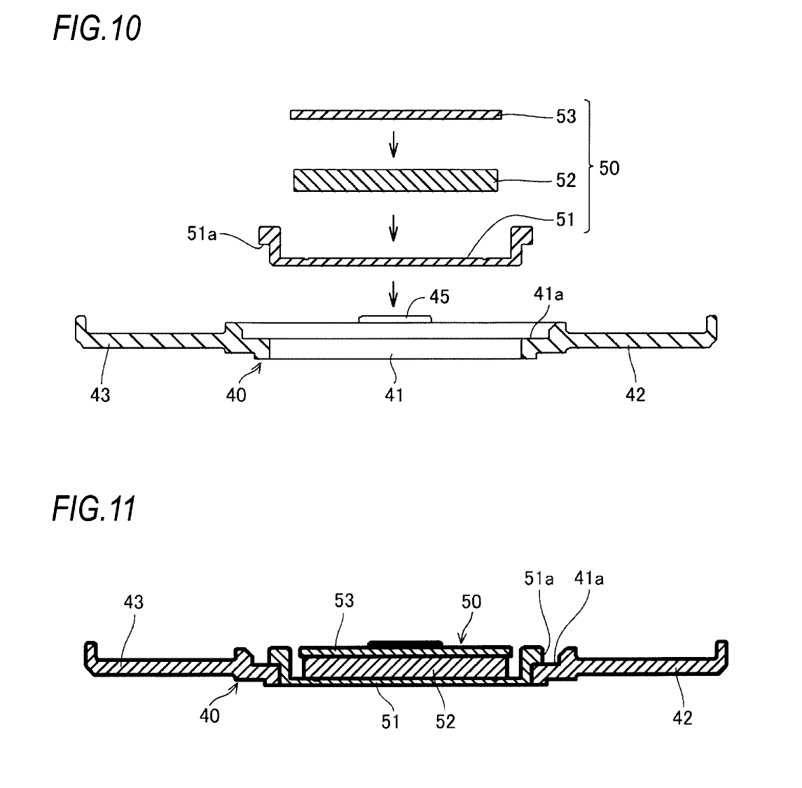

FIG. 10 is a fifth view illustrating a process of manufacturing the speaker system 1.

In FIG. 10 a cross-sectional view of the holding member 40 at a plane in the longitudinal direction thereof is shown. As illustrated in FIG. 10, the cylindrical portion 41 of the holding member 40 has two portions having different inner diameters, and one portion of the cylindrical portion 41 at the front side (upward in FIG. 10) has a large inner diameter. The cylindrical portion 41 is provided with a step portion 41a, which faces the front side, at the other portion having different inner diameter. The pot yoke 51 has an outer diameter so that it is fitted into the portion, which has a small inner diameter of the cylindrical portion 41, and is provided with a flange portion 51a at the front side portion thereof.

FIG. 11 is a sixth view illustrating a process of manufacturing the speaker system 1.

As illustrated in FIG. 11, the pot yoke 51 is positioned to the holding member 40 with respect to the diameter direction of the cylindrical portion 41 in the state in which the magnetic circuit 50 is held by the holding member 40. Also, as the step portion 41a is brought in contact with the flange portion 51a of the pot yoke 51, the pot yoke is positioned to the holding member 40 in an axial direction of the cylindrical portion 41. Accordingly, the magnetic circuit 50 is positioned in the speaker section 2, so that the speaker system 1 is normally operated.

As described above, when the structure S3 and the structure A4 are respectively formed, the speaker system 1 is configured by using the structures.

As illustrated in FIG. 5, the structure A4 is fixed to the structure S3 at step S31. The engaging bosses 42 to 45 are attached to the protrusions 12 to 15 of the baffle board 10, respectively, and thus the holding member 40 with the magnetic circuit 50 attached thereto in advance is fixed to the baffle board 10. As described above, as the engaging bosses 42 to 45 are respectively positioned on the protrusions 12 to 15, the magnetic circuit 50 is positioned. The magnetic circuit 50 is fixed to the baffle board 10 to be positioned on the center portion of the diaphragm 30, that is, the position corresponding to the voice coil 61.

If the process to step S31 is completed by this way, as illustrated in FIG. 2, the state in which the speaker section 2 is attached to the baffle board 10 is obtained, and thus the speaker system 1 is obtained.

In this embodiment, since the respective components configuring the speaker section 2 is directly attached to the baffle board 10, kinds of screws for attachment, packing (sealer) interposed between a general speaker unit and a general baffle board, or the like is not necessary, as compared to the case where a speaker unit configured in a single piece is separately attached to the baffle board 10. Accordingly, the number of components configuring the speaker system 1 can be reduced, thereby reducing a manufacturing cost.

Each of the edge attachment portion 21, the protrusions 12 to 15, the damper attachment portion 18, and the terminal attachment portions 27 and 28 is positioned outer side than the outer circumference of the edge roll portion 35a of the edge 35. That is, each of the diaphragm 30, the dampers 81 and 91, and the magnetic circuit 50 are independently attached to the baffle board 10. Since the speaker section 2 of the speaker system 1 does not have a frame structure for incorporating them, the speaker section 2 can be reduced in size in the thickness direction thereof, thereby being reduced in thickness.

By attaching the respective components configuring the speaker section 2 to the baffle board 10 step by step, the speaker section 2 is configured, and the speaker system 1 is simultaneously configured. As compared to the case where the speaker unit itself is independently assembled and then is attached to the baffle board or the like, the speaker system 1 can be easily and highly precisely assembled by a few steps. Accordingly, it is possible to reduce a cost for manufacturing the speaker system 1.

After the dampers 81 and 91 are fixed to the baffle board 10 in the state in which the dampers are connected to each other by the bridge portions 80a, the two dampers 81 and 91 are separated from each other by removing the bridge portion 80a. This enables the two dampers 81 and 91 to attach to the predetermined positions, respectively, in the easily and reliably positioned state. In particular, since the positions of the two dampers 81 and 91 are unlikely dislocated from each other, the diaphragm 30 or the like can vibrate with high precision.

Also, the dampers 81 and 91 are not attached to the voice coil bobbin 60 to support the voice coil bobbin 60, but support the diaphragm 30. Accordingly, the dampers 81 and 91 can be downsized, and the voice coil bobbin 60 can be decreased in thickness, so that the speaker section 2 is realized as a thin shape.

### Description of Modification

The edge 35 and the diaphragm 30 may be attached to the baffle board from the rear face thereof.

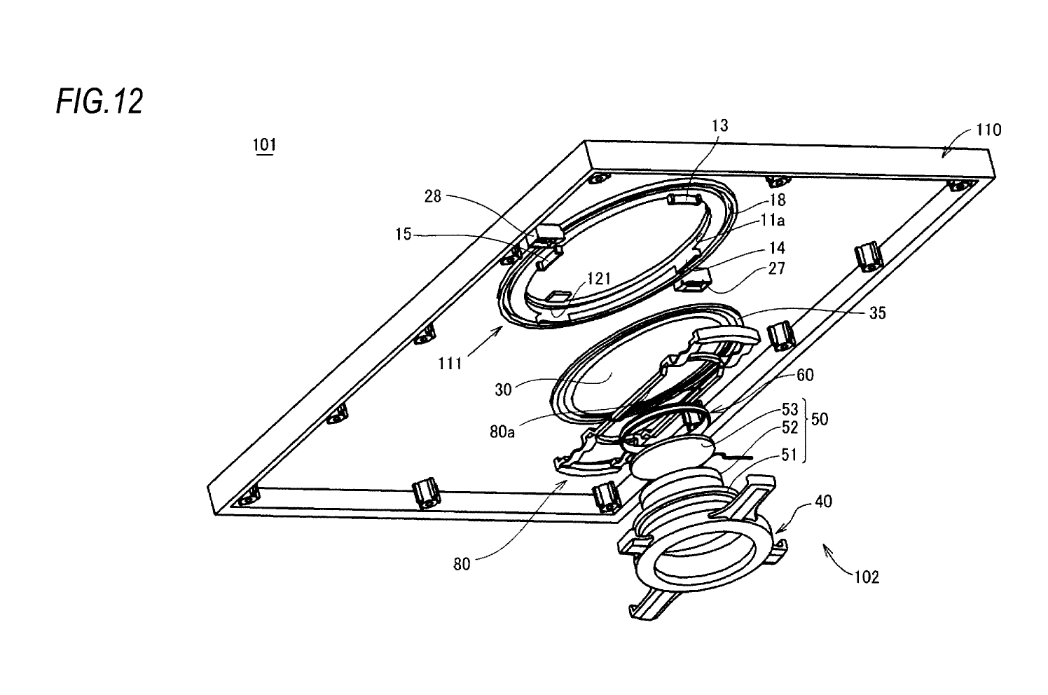

FIG. 12 is an exploded perspective view illustrating a speaker system 101 according to one modification of this disclosure.

As illustrated in FIG. 12, except that a position of an edge attachment portion 121a baffle board 110, of which to which an edge 35 is attached, is different and the diaphragm 30 is attached to the baffle board 110 from the rear face side, the speaker system 101 is similarly to that of the above illustrative embodiment, and the detailed description of similar configurations will be omitted.

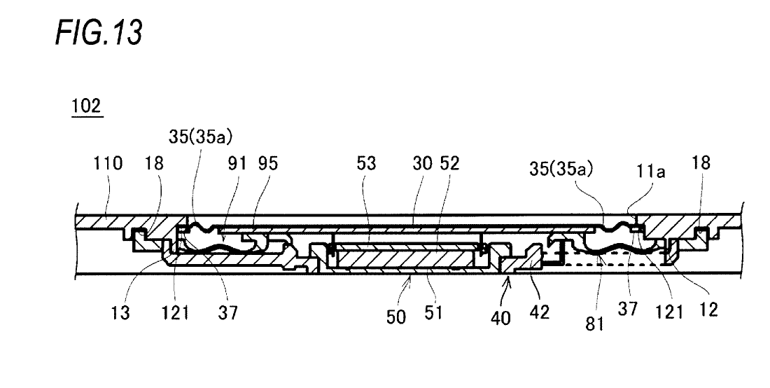

FIG. 13 is a cross-sectional view illustrating a speaker section 102 of the speaker system 101.

The cross-section illustrated in FIG. 13 corresponds to FIG. 3 in the above-described embodiment. As illustrated in FIG. 13, in the speaker system 101, the edge attachment portion 121 has a cross-section of a stepped shape, which is depressed in one step towards the front side (upward in FIG. 13) from the rear side of the baffle board 110. The edge 35 is attached to the edge attachment portion 121 from the rear side of the baffle board 110. The diaphragm 30 and the edge roll portion 35a of the edge 35 are exposed through the opening portion 11a from the front side of the baffle board 110.

The speaker system 101 may be manufactured by attaching the edge 35 and the diaphragm 30 to the baffle board 110 from the rear side thereof and then attaching the dampers 81 and 91, the holding member 40 and the like to the baffle board 110 from the rear side thereof. That is, in this modification, the respective members configuring the speaker section 102 may be attached to the baffle board 110 from the rear side of the baffle board 110. In each process of attaching the speaker section 102 to the baffle board 110, since all working can be carried out at the position face to the rear side of the baffle board 110, it is not necessary to turn the baffle board 110. Accordingly, the speaker system 101 can be easily manufactured by a few steps, and it is possible to reduce a manufacturing cost thereof.

The diaphragm is not limited to the oval shape, as described above. The number of the dampers is not limited to two.

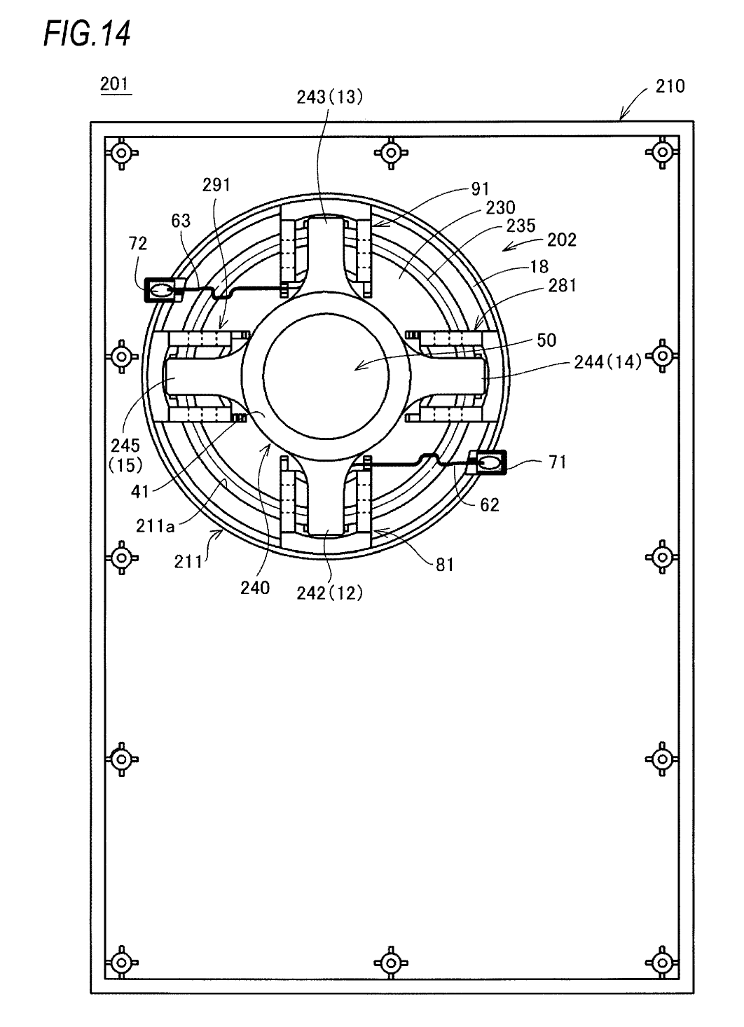

FIG. 14 is a view illustrating a speaker system 201 according to another modification of this disclosure.

As illustrated in FIG. 14, the speaker system 201 is similarly to the above-mentioned embodiment, except for a circular diaphragm 230 and a circular edge 235 when seen from the rear face thereof, and four dampers 81, 91, 281 and 291.

In the speaker system 201, a baffle board 210 is provided with a circular opening portion 211a, and the damper attachment portion 18 and the edge attachment portion (not illustrated) also have a speaker attachment portion 211 of a correspondingly circular shape.

Each of the dampers 81, 91, 281 and 291 has the same shape as that of the above-described damper 81. The dampers 81, 91, 281 and 291 are disposed at an interval of 90 degrees from a center of the speaker attachment portion, that is, at a substantially equal angle from the center of the speaker attachment portion along an outer circumference of the edge 235. The dampers 81 and 91 are disposed at lower and upper portions of the speaker section 202, respectively. Also, the dampers 281 and 291 are disposed at a right side (right side in FIG. 14) and a left side (left side in FIG. 14) of the speaker section 202, respectively.

Each of the dampers 81, 91, 281 and 291 are disposed so that its center is positioned on a straight line which passes through the center of the diaphragm 230, that is, an extension line of the diameter of the diaphragm 30. The extension line of the diameter of the diaphragm 230 passing through the dampers 81 and 91 crosses at right angle with the extension line of the diameter of the diaphragm 230 passing through the dampers 281 and 291. The damper 81 is positioned on the extension of the diameter of the diaphragm 230, and the damper 91 is positioned opposite to the damper 81, with the voice coil (not illustrated in FIG. 14) disposed at the center portion of the diaphragm 230 being interposed between the dampers 81 and 91. Also, the dampers 281 and 291 are respectively disposed on the extension line of the diameter perpendicular to the diameter passing through the damper 81, with the voice coil being interposed between the dampers 281 and 291.

Each of the dampers 81, 91, 281 and 291 is formed to have a substantially symmetrical shape, when seen from the rear face, with respect to the extension line of the diameter of the diaphragm 230 which passes through the dampers. The diaphragm 230 is supported by the respective dampers 81, 91, 281 and 291 at four positions of the lower, upper, right and left portions thereof.

In the modification, the protrusions 12 to 15 are disposed at positions apart from the center portion of the diaphragm 230 at equal intervals, that is, on an end edge portion of the opening portion 211a, according to the shape of the speaker attachment portion 211. The protrusions 12 to 15 are disposed at positions corresponding to the dampers 81, 91, 281 and 291, respectively.

When seen from a rear face, a holding member 240 holding the magnetic circuit 50 has a cross shape, which corresponds to the positions of the respective protrusions 12 to 15. That is, the holding member 240 has engaging bosses 242, 243, 244 and 245 each corresponding to the protrusions 12 to 15. Each of the engaging bosses 242 to 245 has the substantially same shape with each other. The holding member 240 is attached to the baffle board 210 in the state in which the engaging bosses 242 to 245 are positioned by the protrusion 12 to 15.

Additionally, in a process of manufacturing the speaker system 201 according to this modification, the four dampers 81, 91, 281 and 291 are fixed to the baffle board 210 in the state in which the dampers are integrally connected to each other via bridge portions (not illustrated). As the bridge portion, four bridge portions, for example, a bridge portion for connecting the damper 81 and the damper 281, a bridge portion for connecting the damper 281 and the damper 91, a bridge portion for connecting the damper 91 and the damper 291, and a bridge portion for connecting the damper 291 and the damper 81 may be provided. The configuration of the bridge portion is not limited thereto.

Therefore, In the case of using the circular diaphragm 230, the speaker system 201 can be reduced in thickness, as described above. Further, it is possible to decrease the number of components of the speaker systems, and the number of steps required for the assembly.

### Others Configrations

The structure for attaching the magnetic circuit holding member or the damper to the speaker attachment portion of the baffle board is not limited to the above description. For example, the speaker attachment portion may be provided with a recessed portion (one example of a second attachment portion), and a convex portion provided on the magnetic circuit holding member may be fitted into the recessed portion, so that the magnetic circuit holding member is attached to the baffle board with positioning. Further, the speaker attachment portion may be provided with a protrusion (one example of a third attachment portion), and a concave portion provided in the damper may be engaged with the protrusion, so that the damper is attached to the baffle board in the state of being positioned.

The baffle board is not limited to the shape of flat plate utilized in the box like speaker system, like the above-described embodiment. Alternatively, the baffle board may be, for example, an interior material for a vehicle, or a wall face or ceiling of a building.

The baffle board may be configured so that, for example, a separately formed speaker attachment portion is incorporated into the plate-shaped portion thereof to assemble the speaker section.

The speaker system may be an encapsulated type or a bass reflex type of which a baffle board is provided with a bass reflex duct. The speaker system is not limited to the box type. The speaker system may be applied to other types. Further, the single baffle board may be provided with two or more speaker sections.

The plurality of dampers may be separated from each other in advance, and may be separately attached to the baffle board. The damper is not limited to the above-described shape. The movable portion of the respective dampers may be one, or three or more. The connection portion may not be provided.

The number of the dampers, the number of the engaging bosses and protrusions for the magnetic circuit holding member, or the like is not limited to the above description. The number of these components may be odd numbers.

While this disclosure has been illustrated and explained with respect to specific embodiments thereof, it is to be understood that this disclosure is limited thereto but encompasses all changes and modifications that will become possible within the scope of the this disclosure.

What is claimed is:

1. A speaker system comprising:
a baffle board having a first attachment portion, a second attachment portion, and a third attachment portion;
a diaphragm, which is exposed to a front face side of the baffle board;
an edge, which is disposed on an outer circumference of the diaphragm and is fixed to the first attachment portion to support the diaphragm;
a magnetic circuit holding member, which is configured to be fixed to the second attachment portion so that a magnetic circuit is holed at a rear face side of the diaphragm; and
a damper, which is disposed at the rear face side of the diaphragm and is fixed to the third attachment portion to support the diaphragm.

2. The speaker system according to claim 1,
wherein the second attachment portion and the third attachment portion are respectively positioned outer side than an edge roll portion of the edge.

3. The speaker system according to claim 1,
wherein the magnetic circuit holding member has a cylindrical portion, in which the magnetic circuit is disposed, and a plurality of engaging portions protruding laterally from the cylindrical portion, and
wherein the plurality of engaging portions is fixed to the second attachment portion to be positioned at the second attachment portion.

4. The speaker system according to claim 1,
wherein a plurality of the dampers are disposed at a substantially equal angle with respect to a center of a speaker attachment portion.

5. The speaker system according to claim 1,
wherein the damper includes:
a fixing portion that is configured to be fixed to the third attachment portion; and
a pair of movable portions that has a strip shape extending from the fixing portion to a center portion side of the diaphragm, and
wherein the movable portions are respectively attached to the center portion side of the diaphragm.

6. The speaker system according to claim 5,
wherein the pair of movable portions are connected to each other at the center portion side of the diaphragm, and a portion connecting the pair of movable portions is fixed to the diaphragm.

7. The speaker system according to claim 5,
wherein the damper is disposed on a straight line which passes through a center of the diaphragm and crosses at a right angle with the outer circumference of the diaphragm, and
wherein the pair of movable portions is symmetrically disposed, with respect to the straight line, when seen from a direction substantially perpendicular to a vibration face of the diaphragm.

8. The speaker system according to claim 1,
wherein the first attachment portion is formed at the front face side of the baffle board, and
wherein the edge is attached to the first attachment portion from the front side of the baffle board.

9. The speaker system according to claim 1,
wherein the first attachment portion is formed at a rear face side of the baffle board, and
wherein the edge is attached to the first attachment portion from the rear side of the baffle board.

10. The speaker system according to claim 1,
wherein the baffle board has a fourth attachment portion at a rear face side thereof, and a terminal connected to a voice coil via a tinsel wire is fixed to the fourth attachment portion, and
wherein the fourth attachment portion is positioned outer side than the edge roll portion of the edge.

11. A method of manufacturing a speaker system, in which a baffle board is attached with a diaphragm via an edge, a plurality of dampers supports the diaphragm, and a magnetic circuit holding member holds a magnetic circuit, and the dampers and the magnetic circuit holding member is attached to a rear face side of the baffle board, the method comprising:
fixing the plurality of dampers to the baffle board attached with the diaphragm in a state in which the dampers are connected to each other via a bridge portion; and
separating the plurality of dampers from each other by removing the bridge portion, after the fixing the plurality of dampers to the baffle board.

12. The method according to claim 11, further comprising,
fixing the magnetic circuit holding member attached with the magnetic circuit to the baffle board so that the magnetic circuit is positioned at a center portion of the diaphragm, after separating the plurality of dampers from each other.
